(19) United States
(12) Patent Application Publication
(10) Pub. No.: US 2016/0132305 A1
(43) Pub. Date: May 12, 2016

(54) PROGRAM GRAPH DISPLAY DEVICE, PROGRAM GRAPH DISPLAY METHOD, AND PROGRAM GRAPH DISPLAY PROGRAM

(71) Applicant: MITSUBISHI ELECTRIC CORPORATION, Chiyoda-ku, Tokyo (JP)

(72) Inventors: Miya MOROTA, Tokyo (JP); Satoshi NOGUCHI, Tokyo (JP)

(73) Assignee: Mitsubishi Electric Corporation, Chiyoda-ku, Tokyo (JP)

(21) Appl. No.: 14/771,044

(22) PCT Filed: Apr. 8, 2013
(86) PCT No.: PCT/JP2013/060590

§ 371 Date: Aug. 27, 2015

(51) Int. Cl. G06F 9/45

(52) U.S. Cl. CPC G06F 8/433

(57) ABSTRACT

A command code extraction part extracts a command code indicated in an extraction target code list, from an instrument control program. A sub-control program creation part creates a sub-control program including the command code extracted. A sub-control parameter list creation part extracts, from each command code included in the sub-control program, each of one or more elements constituting the command code, as a parameter. A sub-control parameter graph display part creates data of a sub-control parameter graph in which one or more parameters of each command code that have been extracted are associated with each other, and displays the created sub-control parameter graph.

### TECHNICAL FIELD

The present invention relates to a program graph display device, program graph display method, and program graph display method for displaying, for example, a ladder program for a field instrument in a graph format.

### BACKGROUND ART

In a plant manufacturing line and the like, usually, a plurality of field instruments and a CPU (also called CPU unit or PLC) are connected via a network.

The CPU executes an arithmetic program that creates output information to be outputted from the output terminal of a field instrument, based on input information inputted to the input terminal of the field instrument, thereby automatically controlling the field instrument.

CPU is an abbreviation for Central Processing Unit, and PLC is an abbreviation for Programmable logic controller.

As described above, when controlling the field instrument automatically using the CPU, the field instrument and the CPU must communicate with each other. Accordingly, an input/output process for the field instrument takes time.

In order to obtain a high-speed input/output response performance, a field instrument having an arithmetic processing function of creating output information has been developed.

In the field instrument having the arithmetic processing function, a parameter to specify an arithmetic processing is set. The field instrument executes the arithmetic processing according to the preset parameter. Note that there is constraint for an arithmetic processing which a field instrument can execute.

Non-patent Literature 1 discloses a field instrument that performs an arithmetic processing independently.

The field instrument disclosed in Non-patent Literature 1 has a fast logic function that implements high-speed input/output control. The fast logic function is a function of performing an arithmetic processing for input information according to a preset parameter, thus creating output information.

For example, the fast logic function can perform logical operation such as logical product (AND) or logical sum (OR) of two pieces of input information inputted to two input terminals and can output the result of the logical operation to an output terminal.

Parameters to specify the input terminal, the output terminal, and the type of arithmetic operation are set using an exclusive setting tool. The field instrument to which the parameters have been set obtains a high-speed input/output response performance. For example, to a field instrument having a fast logic function, an arithmetic processing function specified by the output terminal, the input terminal, and the type of arithmetic operation are assigned in a fixed manner. When parameters are set using the exclusive setting tool, the arithmetic processing function operates as an effective function.

Patent Literature 1 discloses a field instrument that performs an arithmetic processing in cooperation with another field instrument.

Patent Literature 1 also discloses a technique to set the correspondence of input/output information among field instruments on a network using a setting tool, in order to implement automatic control that does not use a CPU. Information on the correspondence is distributed to each field instrument as a parameter called connection database.

Patent Literature 1, however, does not mention a means for setting a parameter using a setting tool. If a means is employed that sets the transmission/reception correspondence table described in an embodiment of Patent Literature 1 for each field instrument, it will be difficult to perceive the dependency among input and output information of the entire system. This is because the transmission/reception correspondence table is set for each field instrument independently.

If the arithmetic processing is performed among the field instruments without using the CPU, there is often constraint on the arithmetic operations that the field instruments execute, depending on the specifications of the field instruments or of the network. For example, there is constraint that the number of inputs for the arithmetic operation is up to 2, the number of stages of arithmetic operations to be combined is up to 2, an upper-stage arithmetic operation is limited to logical sum, and the like. The constraint on the arithmetic operation differs from one field instrument to another or from one network to another. Therefore, it is necessary to study the setting of the field instruments while taking into consideration the constraint on the arithmetic operation that differs depending on the network or on the field instrument to be employed in a network system as a development target.

Patent Literature 2 discloses how a system developer sets parameters in the field instruments while taking into consideration the constraint on the field instruments or the constraint on the network.

According to Patent Literature 2, a logic chart editing device, when designing a plant control program, automatically checks the constraint on a connection specified on a logic chart.

Conventionally, any connection can be specified if a predetermined condition is satisfied. Accordingly, even a connection such as a connection between different types of terminals, which cannot be established actually can be created on a logic chart. Regarding this, the logic chart editing device according to Patent Literature 2 prevents setting a connection that cannot be established, by checking the constraint on the connection using constraint information.

The system developer needs to create correct constraint information while taking the constraint into consideration, in order that the logic chart editing device performs setting within the constraint range.

### CITATION LIST

### Patent Literature

Patent Literature 1: JP 2000-259208
Patent Literature 2: JP 2004-213277

### Non-Patent Literature

Non-Patent Literature 1: CC-Link IE Field network remote I/O unit, User's manual, Mitsubishi Electric Corporation, December 2012

### SUMMARY OF INVENTION

### Technical Problem

It is, for example, an object of the present invention to enable displaying a ladder program for a field instrument in a graph format.

### Solution to Problem

A program graph display device according to the present invention includes:

an extraction target code storage part to store, among a plurality of command codes included in a target program to be executed by a first execution part and a second execution part, a command code to be executed by the second execution part, as an extraction target code;

a command code extraction part to extract, from among the plurality of command codes included in the target program, a command code that is the same as the extraction target code stored in the extraction target code storage part, as an extracted code;

a second program creating part to create, as a second program to be executed by the second execution part, a program including the extracted code extracted by the command code extraction part;

a parameter extracting part to extract, from each of one or more command codes included in the second program, each of one or more elements constituting the command code, as a parameter; and

a graph data creating part to create graph data that expresses, as a second program graph, a chart in which one or more parameters of each command code are associated with each other, one or more parameters being extracted by the parameter extracting part.

### Advantageous Effects of Invention

According to the present invention, for example, a ladder program (an example of the second program) for a field instrument can be displayed in a graph format.

### BRIEF DESCRIPTION OF DRAWINGS

FIG. 1 is a diagram illustrating a relation between a program editing device 100 and an instrument control device 200 according to Embodiment 1.

FIG. 2 is a functional configuration diagram of the program editing device 100 according to Embodiment 1.

FIG. 3 is a flowchart illustrating a program editing process of the program editing device 100 according to Embodiment 1.

FIG. 4 is a diagram illustrating an example of an instrument control program 210 according to Embodiment 1.

FIG. 5 is a diagram illustrating an example of an extraction target code list 191 according to Embodiment 1.

FIG. 6 is a diagram illustrating an example of an extracted code list 192 according to Embodiment 1.

FIG. 7 is a diagram illustrating an example of a sub-control program 212 according to Embodiment 1.

FIG. 8 is a diagram illustrating an example of a sub-control parameter list 193 according to Embodiment 1.

FIG. 9 is a diagram illustrating an example of a sub-control parameter edit window 310 according to Embodiment 1.

FIG. 10 is a diagram illustrating an example of a main control program 211 according to Embodiment 1.

FIG. 11 is a diagram illustrating an example of the main control program 211 according to Embodiment 1.

FIG. 12 is a diagram illustrating an example of hardware resources of a program editing device 100 according to Embodiment 1.

FIG. 13 is a functional configuration diagram of a program editing device 100 according to Embodiment 2.

FIG. 14 is a diagram illustrating an example of a graph-format display window 410 according to Embodiment 2.

FIG. 15 is a diagram illustrating an example of a table-format display window 420 according to Embodiment 2.

FIG. 16 is a flowchart illustrating a sub-control parameter graph creating process of a sub-control parameter graph display part 161 according to Embodiment 2.

FIG. 17 is a diagram illustrating an example of a sub-control parameter edit window 430 according to Embodiment 3.

FIG. 18 is a functional configuration diagram of a program editing device 100 according to Embodiment 4.

FIG. 19 is a diagram illustrating an example of code constraint data 195 according to Embodiment 4.

FIG. 20 is a diagram illustrating an example of conversion rule data 196 according to Embodiment 4.

FIG. 21 is a flowchart illustrating a code constraint confirmation process of a sub-control program edit part 116 according to Embodiment 4.

FIG. 22 is a diagram illustrating conversion examples of command codes according to Embodiment 4.

FIG. 23 is a diagram illustrating an example of a sub-control parameter edit window 430 according to Embodiment 4.

FIG. 24 is a functional configuration diagram of a program editing device 100 according to Embodiment 5.

### DESCRIPTION OF EMBODIMENTS

### Embodiment 1

An embodiment will be described in which a ladder program for a field instrument is created from a control program for a CPU and the created latter program is edited.

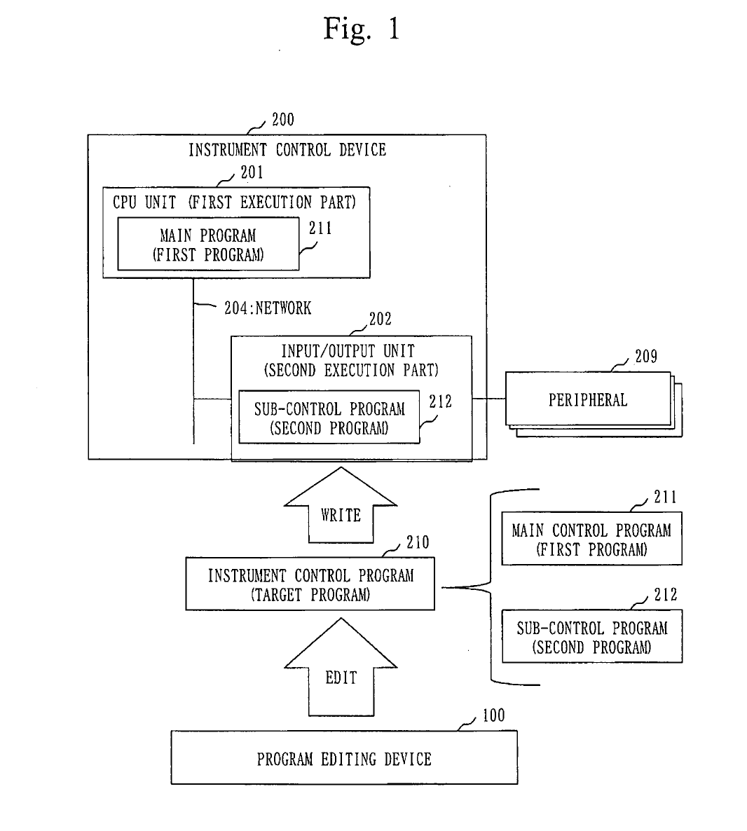

FIG. 1 is a diagram illustrating a relation between a program editing device 100 and an instrument control device 200 according to Embodiment 1.

The relation between the program editing device 100 and the instrument control device 200 according to Embodiment 1 will be described with reference to FIG. 1.

The instrument control device 200 controls peripherals 209 such as a sensor or motor.

For example, the instrument control device 200 is employed in an FA (Factory Automation) system.

The instrument control device 200 includes a CPU unit 201 and an input/output unit 202 (an example of a field instrument).

The CPU unit 201 (an example of a first execution part) is connected to the input/output unit 202 via a network 204 and controls the input/output unit 202 and the peripherals 209 connected to the input/output unit 202.

The CPU unit 201 has an arithmetic operating function (for example, an arithmetic operating element or an arithmetic operation circuit) for executing programs, and executes an instrument control program 210 (excluding a portion to be executed by the input/output unit 202) that serves to control the peripherals 209.

An example of the CPU unit 201 is a programmable logic controller.

The input/output unit 202 (an example of a second execution part) is connected to the peripherals 209 (an example of the field instrument) and inputs/outputs a signal from/to the peripherals 209. For example, the input/output unit 202 inputs an output signal outputted from the peripherals 209, and outputs a control signal for controlling the peripherals 209 to the peripherals 209.

The input/output unit 202 also has an arithmetic operating function, as the CPU unit 201 does, and executes part of the instrument control program 210.

The instrument control program 210 is a program for controlling the peripherals 209.

For example, the instrument control program 210 includes one or more statements (to be referred to as command codes hereinafter) for processing an output signal (for example, a signal representing a measurement value measured by the sensor) from the peripherals 209 and for generating the control signal (for example, a signal for starting or stopping the motor) based on the processing result.

The instrument control program 210 can be either a source program described in a programming language such as a ladder language or C language, or an object program described in a machine language.

The program editing device 100 is a computer that creates a main control program 211 (an example of the first program) and a sub-control program 212 (an example of the second program) by editing the instrument control program 210.

The main control program 211 is a program portion executed by the CPU unit 201, of the instrument control program 210.

The sub-control program 212 is a program portion executed by the input/output unit 202, of the instrument control program 210.

The program editing device 100 will be described hereinafter in detail.

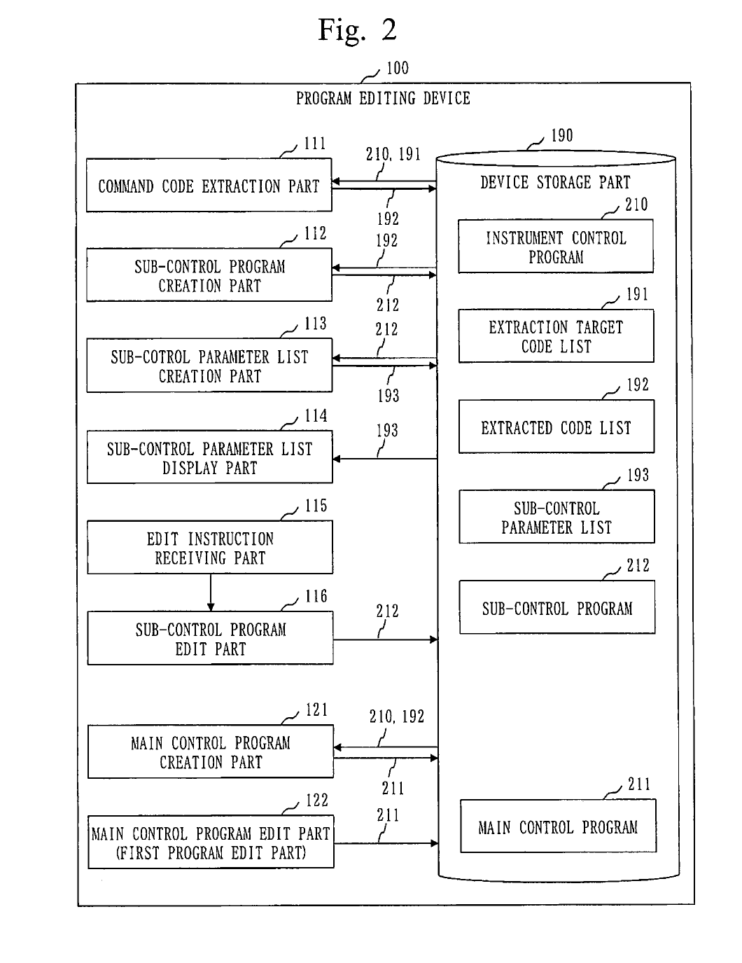

FIG. 2 is a functional configuration diagram of the program editing device 100 according to Embodiment 1.

The functional configuration of the program editing device 100 according to Embodiment 1 will be described with reference to FIG. 2.

The program editing device 100 includes a command code extraction part 111, a sub-control program creation part 112 (an example of a second program creating part), a sub-control parameter list creation part 113 (an example of a parameter extracting part), a sub-control parameter list display part 114 (an example of a second program display part), an edit instruction receiving part 115, and a sub-control program edit part 116 (an example of a second program edit part).

The program editing device 100 includes a main control program creation part 121 (an example of a first program creation part) and a main control program edit part 122 (an example of a first program edit part).

The command code extraction part 111 extracts, from among the command codes included in the instrument control program 210 (an example of a target program), a command code which is the same as an extraction target code indicated in an extraction target code list 191, and creates an extracted code list 192.

The extraction target code list 191 indicates a listing of command codes (extraction target codes) that can be executed by the input/output unit 202.

The extracted code list 192 indicates a listing of command codes (to be referred to as extracted codes hereinafter) extracted from the instrument control program 210.

The sub-control program creation part 112 creates the sub-control program 212 (an example of the second program) including the extracted codes indicated in the extracted code list 192.

The sub-control parameter list creation part 113 creates a sub-control parameter list 193 (an example of second program information) based on the sub-control program 212 or the extracted code list 192.

The sub-control parameter list 193 indicates a listing of sub-control parameters constituting the command codes (to be called sub-control codes hereinafter) included in the sub-control program 212.

The sub-control parameters are constituent elements that make up command codes (sub-control codes) included in the sub-control program 212.

The sub-control parameter list display part 114 displays the sub-control parameters indicated in the sub-control parameter list 193.

The edit instruction receiving part 115 receives edit instructions for the sub-control parameters indicated in the sub-control parameter list 193.

The sub-control program edit part 116 edits the sub-control program 212 in accordance with the edit instruction.

For example, the sub-control program edit part 116 deletes, of the sub-control codes included in the sub-control program 212, a sub-control code specified by the user (a command code to be migrated to the main control program 211) from the sub-control program 212.

The main control program creation part 121 creates the main control program 211 (an example of the first program) by removing the extracted codes indicated in the extracted code list 192 from the instrument control program 210.

The main control program edit part 122 edits the main control program 211.

For example, the main control program edit part 122 adds, of the sub-control codes included in the sub-control program 212, the sub-control code specified by the user (the command code to be migrated to the main control program 211) to the main control program 211.

A device storage part 190 stores data to be used by the program editing device 100.

For example, the device storage part 190 stores the instrument control program 210, the extraction target code list 191, the extracted code list 192, the sub-control parameter list 193, the sub-control program 212, and the main control program 211.

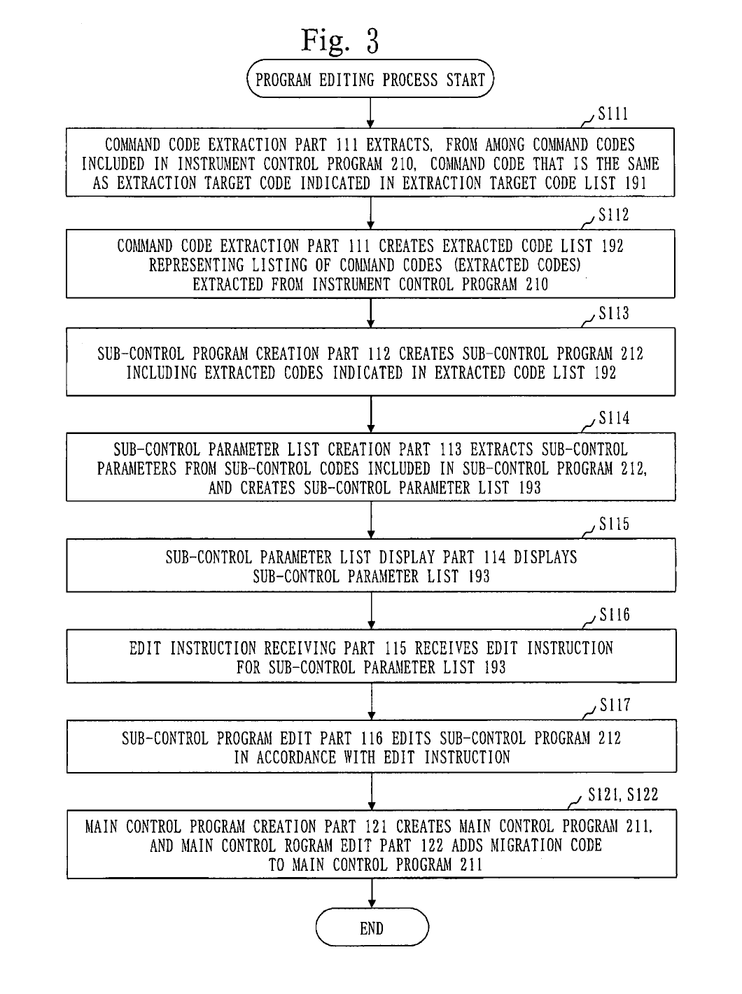

FIG. 3 is a flowchart illustrating a program editing process of the program editing device 100 according to Embodiment 1.

The program editing process of the program editing device 100 according to Embodiment 1 will be described with reference to FIG. 3.

In S111, the command code extraction part 111 extracts, from among the command codes included in the instrument control program 210, a command code that is the same as the extraction target code indicated in the extraction target code list 191.

A same command code may be a command code which is the same completely, including its variable value, a command code having a different variable value but having the same code format, or a command code which is the same regarding the type of command or the type of arithmetic operation.

After S111, the process proceeds to S112.

In S112, the command code extraction part 111 creates the extracted code list 192 which is a listing of the command codes (extracted codes) extracted from the instrument control program 210.

The extracted code list 192 indicates the listing of the extracted codes as well as extracting portion identifiers each identifying, for each extracted code, the extracting portion of the extracted code.

After S112, the process proceeds to S113.

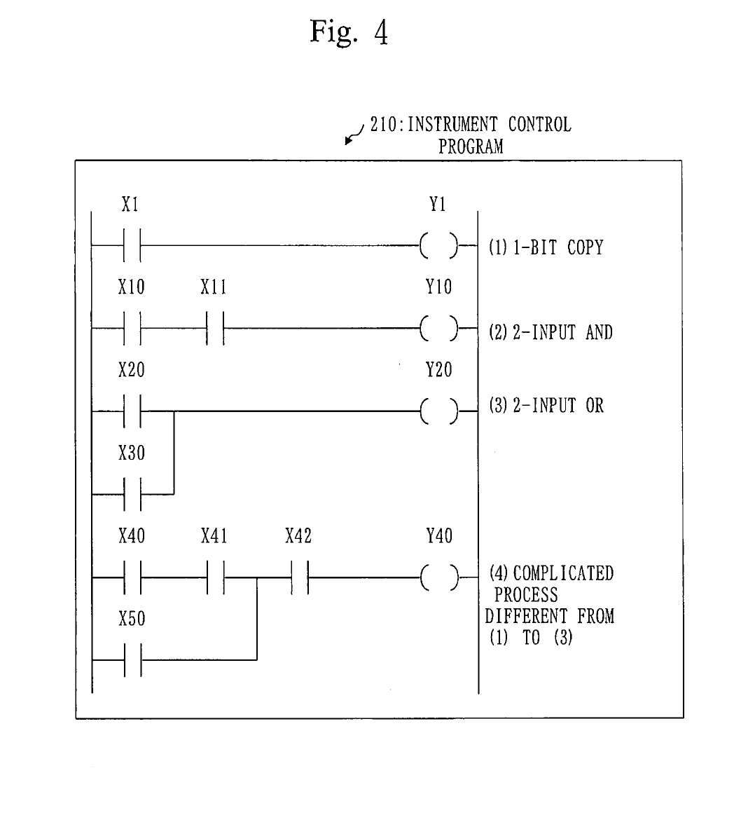

Practical examples of the target code extracting process (S111) and the extracted code list creating process (S112) will be described hereinafter with reference to FIGS. 4, 5, and 6.

FIG. 4 is a diagram illustrating an example of the instrument control program 210 according to Embodiment 1.

The instrument control program 210 illustrated in FIG. 4 is a ladder program described in the ladder language and includes command codes of (1) to (4).

The command code of (1) signifies 1-bit copy, the command code of (2) signifies calculating the logical product of two values, and the command code of (3) signifies outputting the logical sum of two values.

Xn represents a variable value that identifies an input device, and Yn represents a variable value that identifies an output device. This notion applies to drawings that follow FIG. 4 as well.

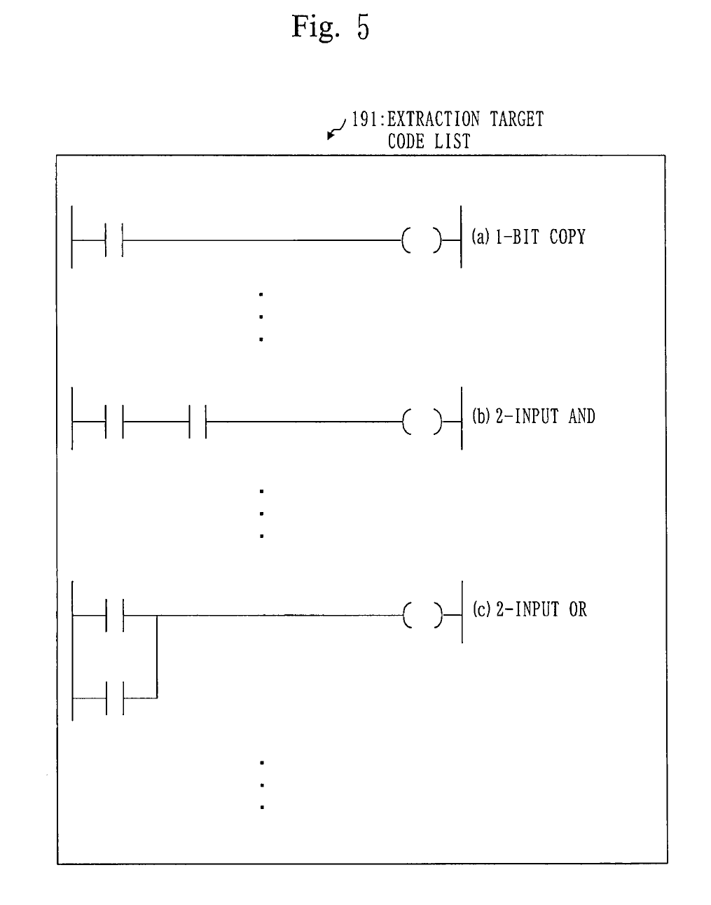

FIG. 5 is a diagram illustrating an example of the extraction target code list 191 according to Embodiment 1.

The extraction target code list 191 illustrated in FIG. 5 indicates extraction target codes of (a) to (c) described in the ladder language.

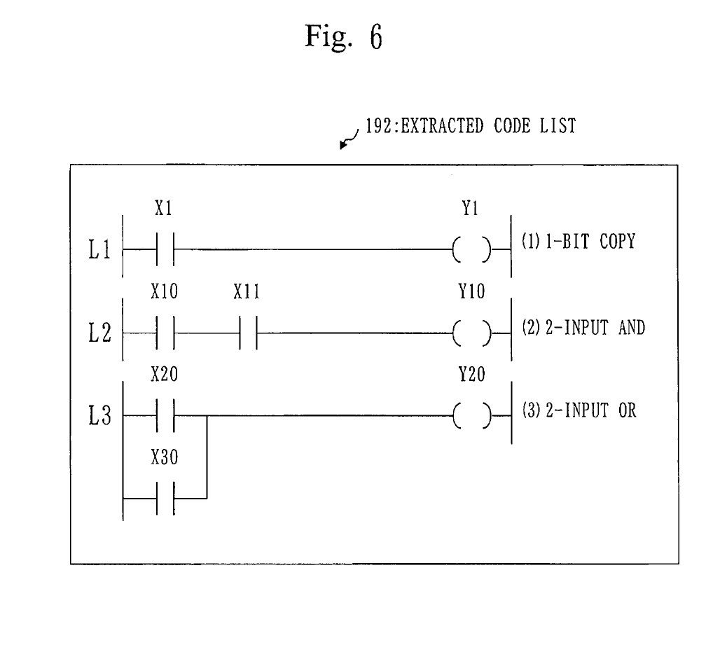

FIG. 6 is a diagram illustrating an example of the extracted code list 192 according to Embodiment 1.

The extracted code list 192 illustrated in FIG. 6 indicates extracted codes of (1) to (3) described in the ladder language.

The extracted code list 192 also indicates extracting portion identifies (for example, line number in the instrument control program 210) each identifying, for each extracted code, an extracting portion where the extracted code has been extracted. L1 to L3 in FIG. 6 denote the extracting portion identifiers. Ln signifies that a code has been extracted from the nth line in the instrument control program 210.

Of the command codes of (1) to (4) included in the instrument control program 210 of FIG. 4, the command codes of (1) to (3) are command codes that are the same as the extraction target codes of (a) to (c) indicated in the extraction target code list 191 of FIG. 5. Namely, the command codes of (1) to (3) are of the same code format type and the same command (arithmetic operation) type as those of the command codes of (a) to (c).

The command code of (4) of the instrument control program 210 is a command code that is different from any extraction target code indicated in the extraction target code list 191.

Accordingly, the command code extraction part 111 extracts the command codes of (1) to (3) from among the command codes of (1) to (4) included in the instrument control program 210 (S111 of FIG. 3), and creates the extracted code list 192 of FIG. 6 (S112 of FIG. 3).

Returning to FIG. 3, the explanation will resume with S113.

In S113, the sub-control program creation part 112 creates the sub-control program 212 including the extracted codes indicated in the extracted code list 192.

After S113, the process proceeds to S114.

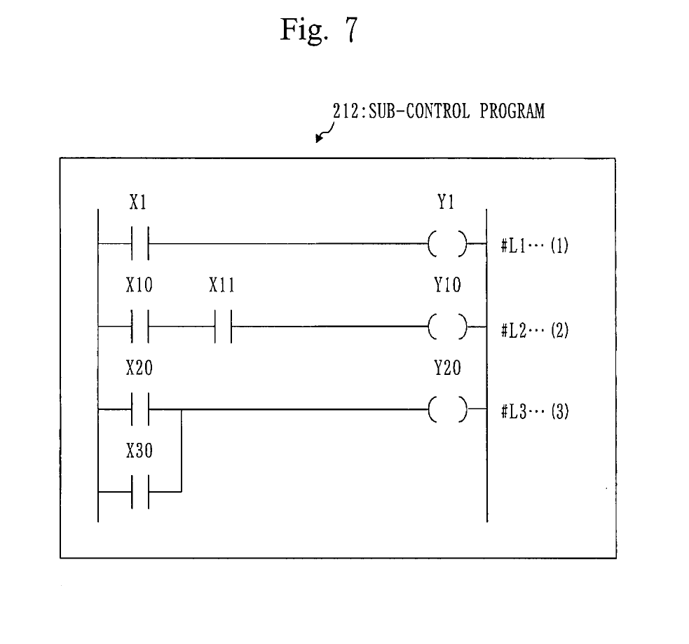

A practical example of the sub-control program creating process (S113) will be described with reference to FIG. 7.

FIG. 7 is a diagram illustrating an example of the sub-control program 212 according to Embodiment 1.

The sub-control program 212 indicated in FIG. 7 is a ladder program and includes command codes of (1) to (3).

The sub-control program creation part 112 creates the sub-control program 212 of FIG. 7 based on the extracted code list 192 of FIG. 6.

More specifically, the sub-control program creation part 112 creates the sub-control program 212 of FIG. 7 by arranging the extracted codes of (1) to (3) indicated in the extracted code list 192 of FIG. 6, according to the corresponding extracting portion identifiers Ln.

Also, the sub-control program creation part 112 may add extracting portion identifiers Ln to the extracted codes of (1) to (3). For example, the sub-control program creation part 112 adds a comment # Ln indicating an extracting portion identifier.

Returning to FIG. 3, the explanation will resume with S114.

In S114, the sub-control parameter list creation part 113 extracts sub-control parameters from the sub-control codes (command codes) included in the sub-control program 212, and creates the sub-control parameter list 193 indicating a listing of the extracted sub-control parameters.

Alternatively, the sub-control parameter list creation part 113 may create the sub-control parameter list 193 using the extracted code list 192 instead of the sub-control program 212.

After S114, the process proceeds to S115.

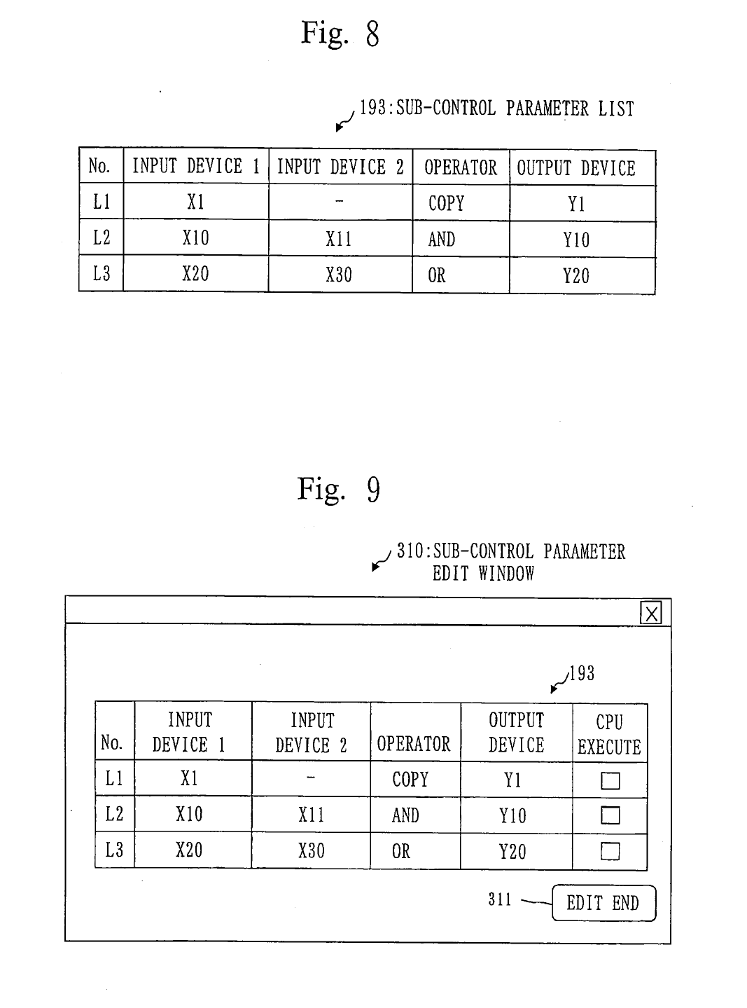

A practical example of a sub-control parameter list creating process (S114) will be described with reference to FIG. 8.

FIG. 8 is a diagram illustrating an example of the sub-control parameter list 193 according to Embodiment 1.

The sub-control parameter list 193 illustrated in FIG. 8 indicates sub-control parameters of No. 1 to No. 3.

The sub-control parameters include “No.”, “Input Device 1”, “Input Device 2”, “Operator”, and “Output Device”.

“No.” represents an extracting portion identifier that identifies an extracting portion where the sub-control code has been extracted from the instrument control program 210.

“Input Device 1” represents an identifier that identifies a first input device, being a value input source, among constituent elements constituting the command code.

“Input Device 2” represents an identifier that identifies a second input device, being a value input source, among the constituent elements constituting the command code.

“Operator” represents an identifier that identifies the type of arithmetic operation among constituent elements constituting the command code.

“Output Device” is an identifier that identifies an output device, being a value output destination, among the constituent elements constituting the command code.

The sub-control parameter list creation part 113 creates the sub-control parameter list 193 of FIG. 8 based on the sub-control program 212 of FIG. 7.

More specifically, for each one of command codes of (1) to (3) included in the sub-control program 212 of FIG. 7, the sub-control parameter list creation part 113 extracts sub-control parameters from the command code.

Then, the sub-control parameter list creation part 113 creates the sub-control parameter list 193 of FIG. 8 which indicates, for each one of command codes of (1) to (3), the sub-control parameters extracted from the command code.

Alternatively, the sub-control parameter list creation part 113 may create the sub-control parameter list 193 of FIG. 8 using the extracted code list 192 of FIG. 6 instead of the sub-control program 212 of FIG. 7.

In the sub-control parameter list 193 of FIG. 8, the sub-control parameters of L1 are sub-control parameters constituting the command code of (1), among command codes (1) to (3) of FIG. 7 or 6, which is associated with the extracting portion identifier L1.

Likewise, the sub-control parameters of L2 are sub-control parameters constituting the command code of (2) of FIG. 7 or 6. The sub-control parameters of L3 are sub-control parameters constituting the command code of (3) of FIG. 7 or 6.

Returning to FIG. 3, the explanation will resume with S115.

In S115, the sub-control parameter list display part 114 displays the sub-control parameters indicated in the sub-control parameter list 193.

For example, the sub-control parameter list display part 114 displays a sub-control parameter edit window 310 as illustrated in FIG. 9.

FIG. 9 is a diagram illustrating an example of the sub-control parameter edit window 310 according to Embodiment 1.

The sub-control parameter edit window 310 of FIG. 9 includes the sub-control parameter list 193 of FIG. 8 which is expressed in the table format. The sub-control parameter edit window 310 additionally includes “CPU execute” fields.

Each “CPU execute” field includes a check box for specifying a sub-control code to be executed by the CPU unit 201, namely, a sub-control code to be migrated to the main control program 211.

Each display field of the sub-control parameter list 193 is an editable text box. An editing means (such as a pull-down list or menu) other than a text box may be employed instead.

The sub-control parameter edit window 310 also includes an edit end button 311 for instructing end of editing the sub-control parameter list 193.

Hereinafter, a sub-control code specified as a command code to be executed by the CPU unit 201, namely, as a command code to be migrated to the main control program 211, will be referred to as a “migration code”.

After S115, the process proceeds to S116.

In S116, the user enters an edit instruction (add, change, delete, or the like) for the displayed sub-control parameter to the program editing device 100 using an input instrument such as a keyboard or mouse.

For example, the user changes an input device 1 of L1 displayed on the sub-control parameter edit window 310 of FIG. 9, from “X1” to “X2”, and depresses the edit end button 311.

For example, if the user wishes to have the CPU unit 201 execute a sub-control code concerning the sub-control parameter of L1 displayed on the sub-control parameter edit window 310 of FIG. 9, the user checks the check box of the “CPU execute” field of L1 and depresses the edit end button 311.

Then, the edit instruction receiving part 115 receives the edit instruction entered by the user from the input instrument.

After S116, the process proceeds to S117.

In S117, the sub-control program edit part 116 edits the sub-control codes included in the sub-control program 212 in accordance with the edit instruction of the user.

The sub-control program edit part 116 may edit the sub-control parameter list 193 according to the edit instruction of the user and create an edited sub-control program 212 based on an edited sub-control parameter list 193.

For example, if the input device 1 of L1 on the sub-control parameter edit window 310 of FIG. 9 is changed from “X1” to “X2”, the sub-control program edit part 116 selects the sub-control code of (1) associated with the extracting portion identifier L1, from the sub-control codes of (1) to (3) included in the sub-control program 212 of FIG. 7. Then, the sub-control program edit part 116 changes the identifier of the input device included in the selected sub-control code (1), from “X1” to “X2”.

For example, if the check box of the “CPU execute” field of L1 on the sub-control parameter edit window 310 of FIG. 9 is checked, the sub-control program edit part 116 deletes, among the sub-control codes of (1) to (3) included in the sub-control program 212 of FIG. 7, the sub-control code of (1) associated with the extracting portion identifier L1. The sub-control code of (1) is a migration code to be migrated to the main control program 211.

After S117, the process proceeds to S121.

In S121, the main control program creation part 121 creates the main control program 211 by removing the extracted codes indicated in the extracted code list 192 from the instrument control program 210.

After S121, the process proceeds to S122.

A practical example of the main control program creating process (S121) will be described hereinafter with reference to FIGS. 8 and 9.

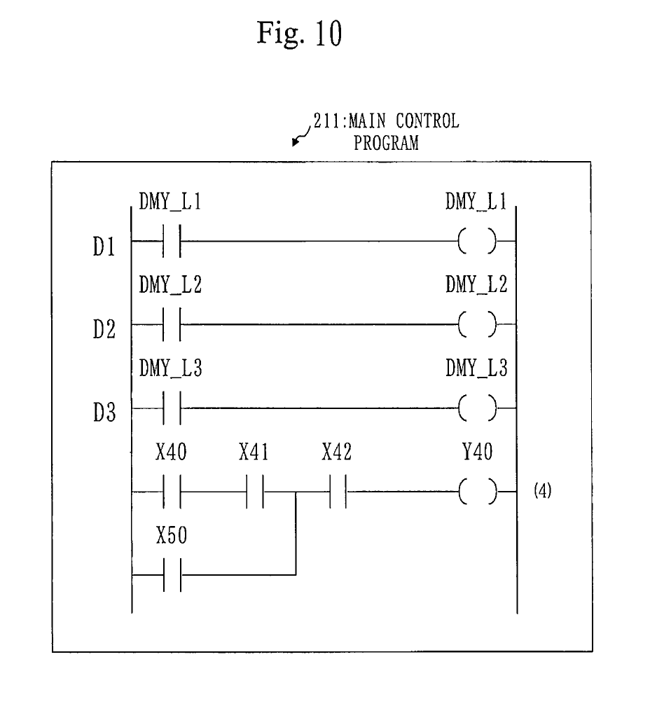

FIG. 10 is a diagram illustrating an example of the main control program 211 according to Embodiment 1.

The main control program 211 illustrated in FIG. 10 is a ladder program and includes dummy codes of D1 to D3 and a command code of (4). A dummy code is an invalid command code that will not be executed. Namely, even if the main control program 211 is compiled, an object code (also called execution code or machine code) corresponding to the dummy code will not be created.

Based on the instrument control program 210 of FIG. 4 and the extracted code list 192 of FIG. 6, the main control program creation part 121 creates the main control program 211 of FIG. 10.

More specifically, from among the command codes of (1) to (4) included in the instrument control program 210 of FIG. 4, the main control program creation part 121 specifies the command codes of (1) to (3) indicated in the extracted code list 192 of FIG. 6 based on their corresponding extracting portion identifiers Ln.

Then, the main control program creation part 121 replaces the specified command codes of (1) to (3) by dummy codes, thereby creating the main control program 211 of FIG. 10.

D1 to D3 of FIG. 10 are dummy codes. A character string DMY_Ln including an extracting portion identifier Ln of the corresponding extracted code is set in each dummy code.

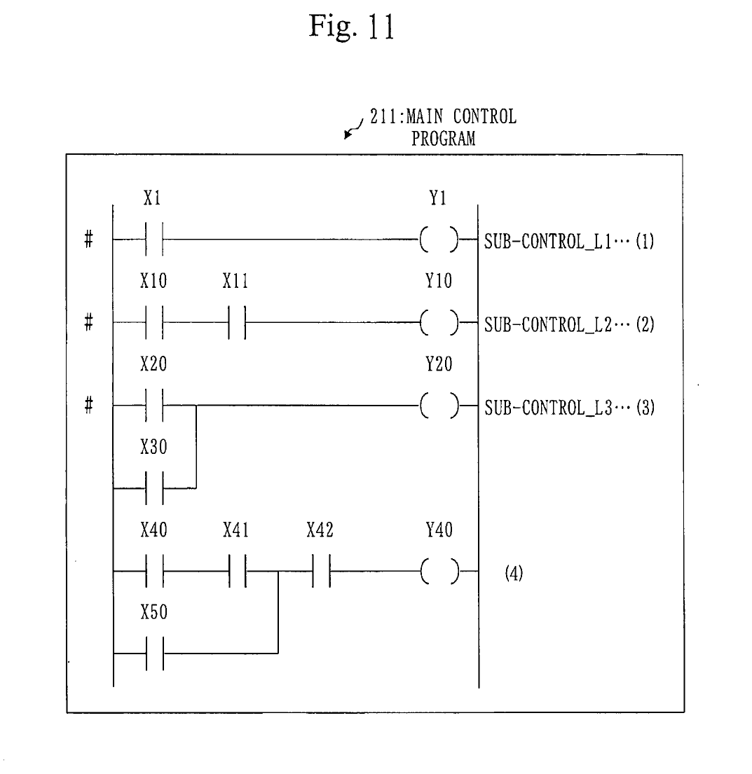

FIG. 11 is a diagram illustrating an example of the main control program 211 according to Embodiment 1.

The main control program 211 indicated in FIG. 11 includes comment lines each attached with a symbol #, and a command code of (4).

The main control program creation part 121 may create the main control program 211 of FIG. 11 based on the instrument control program 210 of FIG. 4 and the extracted code list 192 of FIG. 6.

More specifically, among the command codes of (1) to (4) included in the instrument control program 210 of FIG. 4, the main control program creation part 121 may replace the command codes of (1) to (3) indicated in the extracted code list 192 of FIG. 6 by comment lines, instead of replacing them by dummy codes.

The main control program creation part 121 may add a comment sub-control_Ln to a comment line to indicate that this comment line is a command code migrated to the sub-control program 212.

Returning to FIG. 3, the explanation will resume with S122.

In S122, the main control program edit part 122 adds the migration code specified by the edit instruction of the user, to the main control program 211.

For example, when the check box of the “CPU execute” field for L1 is checked in the sub-control parameter edit window 310 of FIG. 9, the main control program edit part 122 selects a dummy code of D1 associated with an extracting portion identifier L1, from among dummy codes of D1 to D3 included in the main control program 211 of FIG. 10. The main control program edit part 122 then converts (restores) the selected dummy code of D1 into an ordinary command code, thereby adding a migration code to the main control program 211. The migration code to be added to the main control program 211 is a sub-control code of (1) which has been deleted from the sub-control program 212 in S117.

After S122, the program editing process ends. If, however, a migration code is not specified by the edit instruction of the user, the program editing process ends without performing S122.

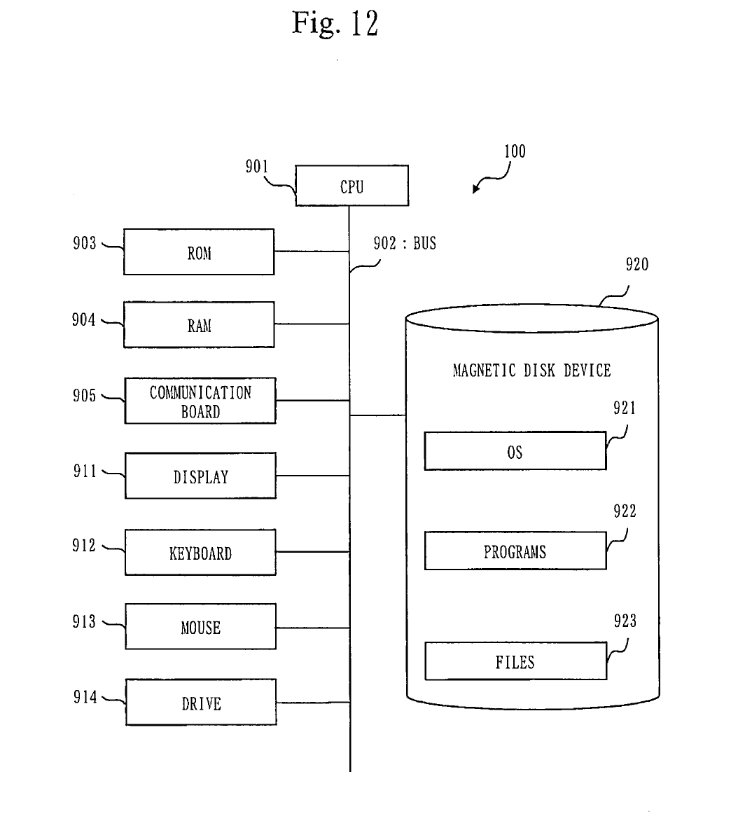

FIG. 12 is a diagram illustrating an example of the hardware resources of the program editing device 100 according to Embodiment 1.

Referring to FIG. 12, the program editing device 100 (an example of a computer) includes a CPU 901 (Central Processing Unit). The CPU 901 is connected to hardware devices such as a ROM 903, a RAM 904, a communication board 905 (communication device), a display 911 (display device), a keyboard 912, a mouse 913, a drive 914, and a magnetic disk device 920 via a bus 902, and controls these hardware devices. The drive 914 is a device that reads from and writes to a storage medium such as an FD (Flexible Disk), a CD (Compact Disc), or a DVD (Digital Versatile Disc).

The ROM 903, RAM 904, magnetic disk device 920, and drive 914 are examples of a storage device. The keyboard 912, mouse 913, and communication board 905 are examples of an input device. The display 911 and communication board 905 are examples of an output device.

The communication board 905 is connected to a communication network such as a LAN (Local Area Network), internet, or telephone line by wire or in a wireless manner.

The magnetic disk device 920 stores an OS 921 (Operating System), programs 922, and files 923.

The programs 922 include a program that executes a function explained as “part” in the embodiment. The program (for example, a program graph display program) is read and executed by the CPU 901. More specifically, the program causes the computer to function as the “part”, and causes the computer to execute the procedure and method of the “part”.

The files 923 include various types of data (input, output, decision result, calculation result, processing result, and the like) used in the “part” explained in the embodiment.

The arrows included in the configuration diagrams and flowcharts in the embodiment mainly indicate inputs and outputs of data and signals.

The process of the embodiment described based on the flowcharts and the like is executed using hardware such as the CPU 901, the storage device, the input device, and the output device.

What is explained as “part” in the embodiment may be “circuit”, “device”, or “instrument”; or “step”, “procedure”, or “process”. Namely, the “part” may be implemented as firmware, software, or hardware; or by a combination of them.

Embodiment 1 provides, for example, the following effects.

The program editing device 100 can automatically extract an input/output response control program (sub-control program) to be executed by a high-speed response input/output unit having an arithmetic operating function, from a control program to be executed on the CPU unit.

The user can edit the sub-control program 212 easily without programming.

The user can assess the processing share between the CPU unit and the input/output unit easily.

The user can migrate a sub-control code included in the sub-control program 212 to the main control program 211.

### Embodiment 2

An embodiment will be described in which a sub-control program 212 (for example, a ladder program for a field instrument) is displayed visually.

Matters that are different from Embodiment 1 will mainly be described hereinafter. Matters that are not described are the same as Embodiment 1.

Note that the input/output unit 202 and the peripherals 209 illustrated in FIG. 1 are called field instruments as well.

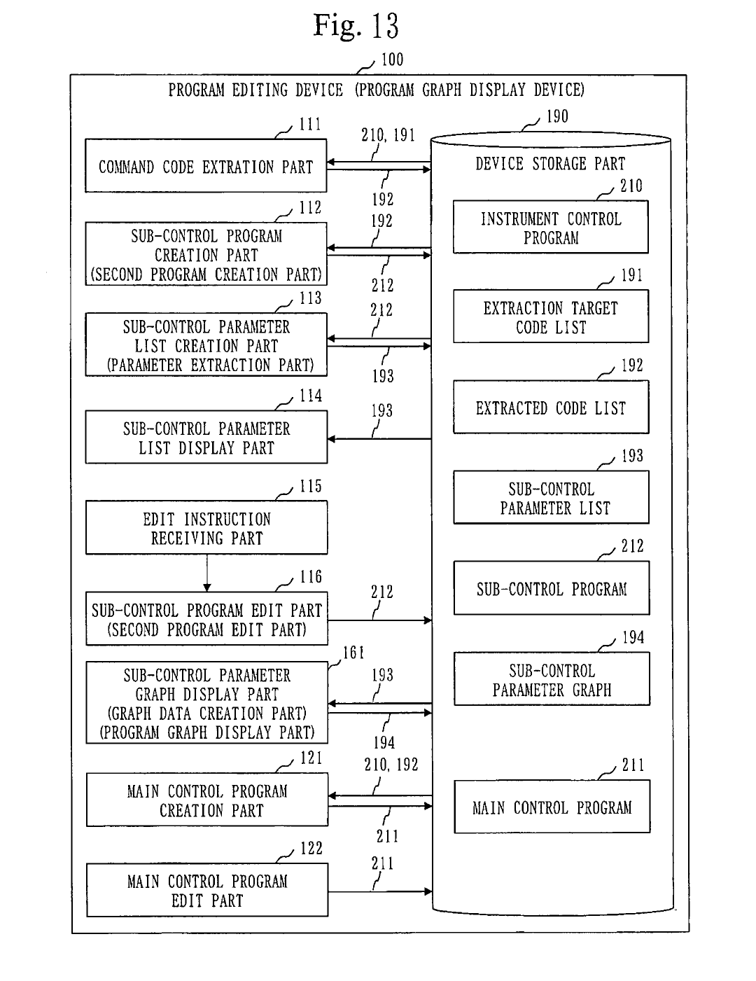

FIG. 13 is a functional configuration diagram of a program editing device 100 according to Embodiment 2.

The functional configuration of the program editing device 100 according to Embodiment 2 will be described with reference to FIG. 13.

The program editing device 100 (an example of a program graph display device) includes a sub-control parameter graph display part 161 (an example of a graph data creating part and program graph display part) in addition to the configuration described in Embodiment 1 (see FIG. 2).

The sub-control parameter graph display part 161 displays a sub-control parameter list 193 in a graph format.

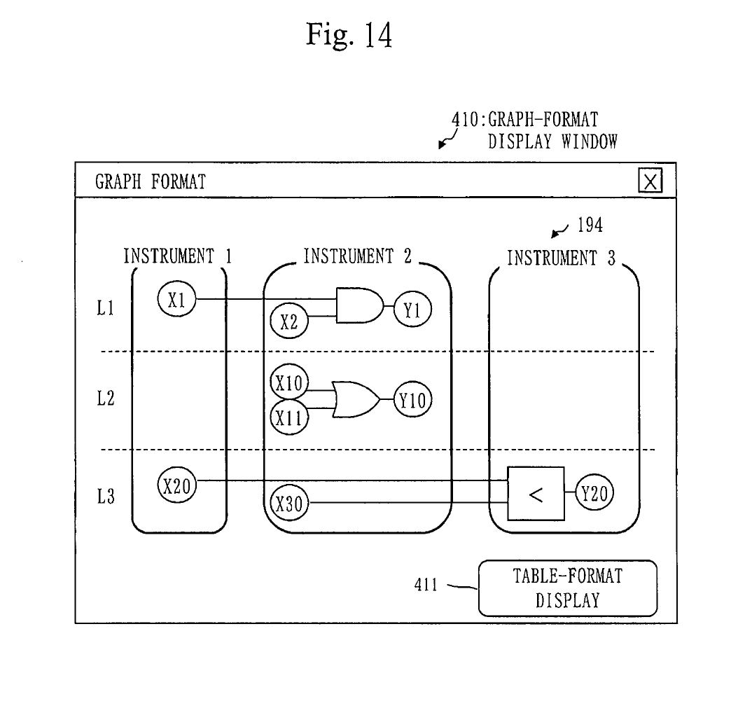

When the user specifies graph-format display of the sub-control parameter list 193 to the program editing device 100, the sub-control parameter graph display part 161 creates the data of a sub-control parameter graph 194 based on the sub-control parameter list 193 and displays a graph-format display window 410 as illustrated in FIG. 14.

FIG. 14 is a diagram illustrating an example of the graph-format display window 410 according to Embodiment 2.

As illustrated in FIG. 14, the graph-format display window 410 includes the sub-control parameter graph 194 and a table-format display button 411.

The data of the sub-control parameter graph 194 is a graphical presentation of the sub-control parameter list 193.

The table-format display button 411 is a button (an example of a user interface) for specifying a switch-over to a table-format display window 420 that indicates the sub-control parameter list 193 in a table format.

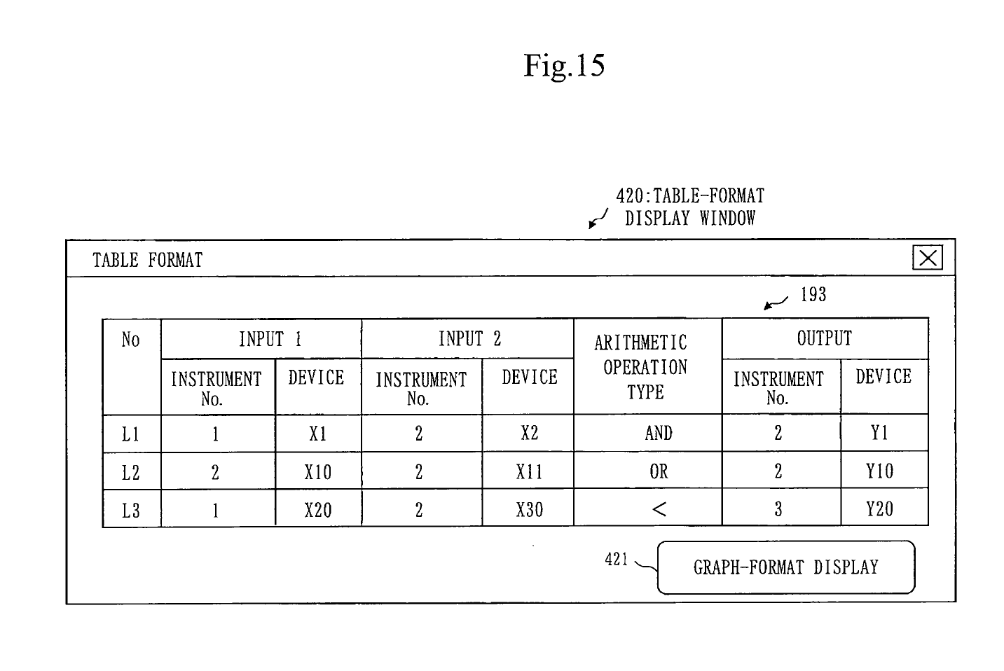

When the table-format display button 411 on the graph-format display window 410 is depressed, a sub-control parameter list display part 114 displays the table-format display window 420 as illustrated in FIG. 15 based on the sub-control parameter list 193. The display method of the table-format display window 420 is the same as the display method of the sub-control parameter edit window 310 (see FIG. 9).

FIG. 15 is a diagram illustrating an example of the table-format display window 420 according to Embodiment 2.

As illustrated in FIG. 15, the table-format display window 420 includes the table-format sub-control parameter list 193 and a graph-format display button 421.

The graph-format display button 421 is a button for specifying a switch-over to the graph-format display window 410 that indicates the sub-control parameter list 193 in a graph format.

If the user specifies table-format display to the program editing device 100 before specifying the graph-format display of the sub-control parameter list 193, the sub-control parameter list display part 114 displays the table-format display window 420 as illustrated in FIG. 15 based on the sub-control parameter list 193.

Returning to FIG. 14, the explanation will resume with the graph-format display window 410.

The sub-control parameter graph 194 illustrated in FIG. 14 is a graphical presentation of the content of the sub-control parameter list 193 illustrated in FIG. 15.

For example, the upper portion of the sub-control parameter graph 194 illustrates the command code of L1, the middle portion of the sub-control parameter graph 194 illustrates the command code of L2, and the lower portion of the sub-control parameter graph 194 illustrates the command code of L3.

The sub-control parameter graph 194 indicates, for each command code, a field instrument as the input source of input data, an input terminal (input device) of the field instrument, a field instrument as an output destination of output data, an output terminal (output device) of the field instrument, and the type of arithmetic operation (an arithmetic operating element or arithmetic operation circuit). The field instrument is an input/output unit 202, a peripheral 209, or the like.

The sub-control parameter graph 194 associates the input terminal, the output terminal, and the type of arithmetic operation with each other by connecting an icon representing the input terminal, an icon representing the output terminal, and an icon representing the type of arithmetic operation, with lines.

The sub-control parameter graph 194 expresses icons that differ depending on the type of arithmetic operation.

For example, the logical product of L1, the logical sum of L2, and the magnitude comparison of L3 are expressed by icons having different shapes. Alternatively, the icons of the arithmetic operations may be different in their notation other than the shape (for example, the color).

In the sub-control parameter graph 194, the input terminals and the output terminals are expressed as circular icons.

The input terminals and the output terminals may be expressed as different icons (for example, circular icons and square icons).

In the sub-control parameter graph 194, the input terminals and output terminals of each field instrument are surrounded by a line.

For example, the frame line of the field instrument “Instrument 1” of No. 1 surrounds an input terminal “X1” of the command code L1 and an input terminal “X20” of the command code L3.

Namely, the data of the sub-control parameter graph 194 includes information specifying the types of icons (shape, color, and the like), connection lines that connect related icons, the display positions of the icons, and the like.

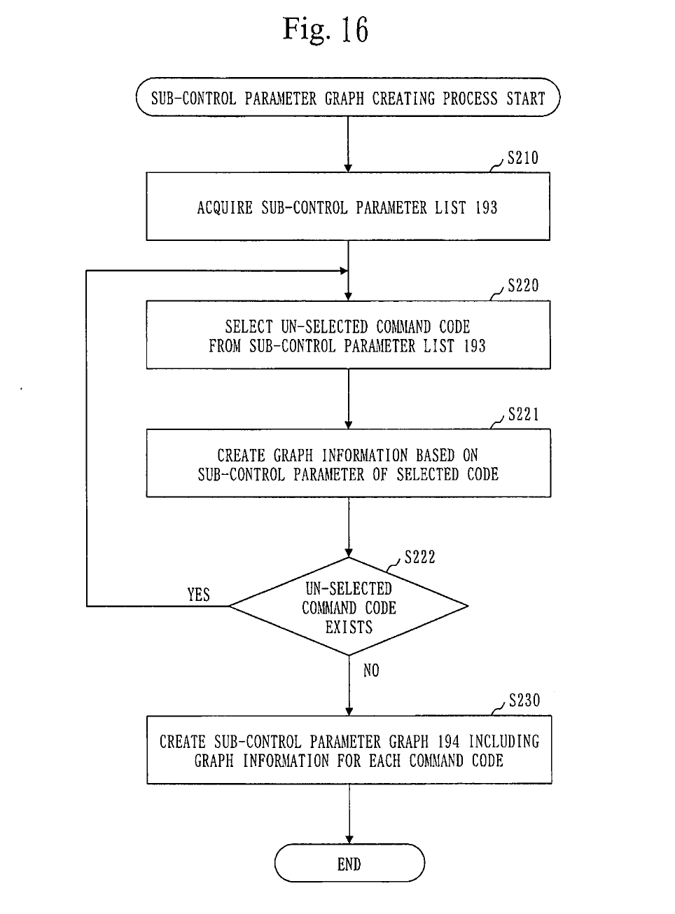

FIG. 16 is a flowchart illustrating the sub-control parameter graph creating process of the sub-control parameter graph display part 161 according to Embodiment 2.

The processing method of the sub-control parameter graph display part 161 according to Embodiment 2 will be described by referring to FIG. 16.

In S210, the sub-control parameter graph display part 161 acquires the sub-control parameter list 193 from a device storage part 190.

After S210, the process proceeds to S220.

In S220, the sub-control parameter graph display part 161 selects one un-selected command code from the sub-control parameter list 193. The command code selected in S220 will be referred to as “selected code” hereinafter.

After S220, the process proceeds to S221.

In S221, the sub-control parameter graph display part 161 creates graph information such as an icon for the input terminal, an icon for the output terminal, an icon expressing the type of arithmetic operation, connection lines that connect the icons, the display positions of the icons, and the like based on the sub-control parameter of the selected code.

The graph representation data (for example, icon data) necessary for creating the graph information is stored in the device storage part 190 in advance. For example, the icon data is data that associates the icons with the types of icons (the input terminal, the output terminal, logical product, logical sum, and the like).

After S221, the process proceeds to S222.

In S222, the sub-control parameter graph display part 161 decides whether or not an un-selected command code is left in the sub-control parameter list 193.

If an un-selected command code is left (YES), the process returns to S220.

If an un-selected command code is not left (NO), the process proceeds to S230.

In S230, the sub-control parameter graph display part 161 creates data of the sub-control parameter graph 194 including the graph information created in S221 for each command code.

After S230, the sub-control parameter graph creating process ends.

According to Embodiment 2, the sub-control program 212 can be displayed visually. Also, the user can assess the inputs/outputs of the field instruments and the relation among the arithmetic operation processes visually.

Embodiment 1 or 2, or subsequent embodiments may have a configuration as follows.

(1) The extraction target code list 191 and the extracted code list 192 may indicate command codes in a structure format such as C language. A structure that expresses a command code is data including the type of arithmetic operation (for example, a logical product or logical sum), an input (for example, an instrument identifier or a terminal name), an output (for example, an instrument identifier or a terminal name), and the like.

(2) The program editing device 100 may include a program write part that writes the sub-control program 212 to the memory of the field instrument by transmitting the sub-control program 212 (or at least some command code included in the sub-control program 212) to the field instrument (the input/output unit 202, the peripherals 209, or the like). For example, the program write part converts the data format of the sub-control program 212 into such a data format that can be written to the field instrument, and writes the converted sub-control program 212 to the field instrument.

### Embodiment 3

An embodiment in which a sub-control program 212 displayed in graph format is edited will be described hereinafter.

Matters that are different from Embodiment 2 will mainly be described hereinafter. Matters that are not described are the same as Embodiment 2.

The functional configuration of a program editing device 100 is the same as Embodiment 2 (see FIG. 13).

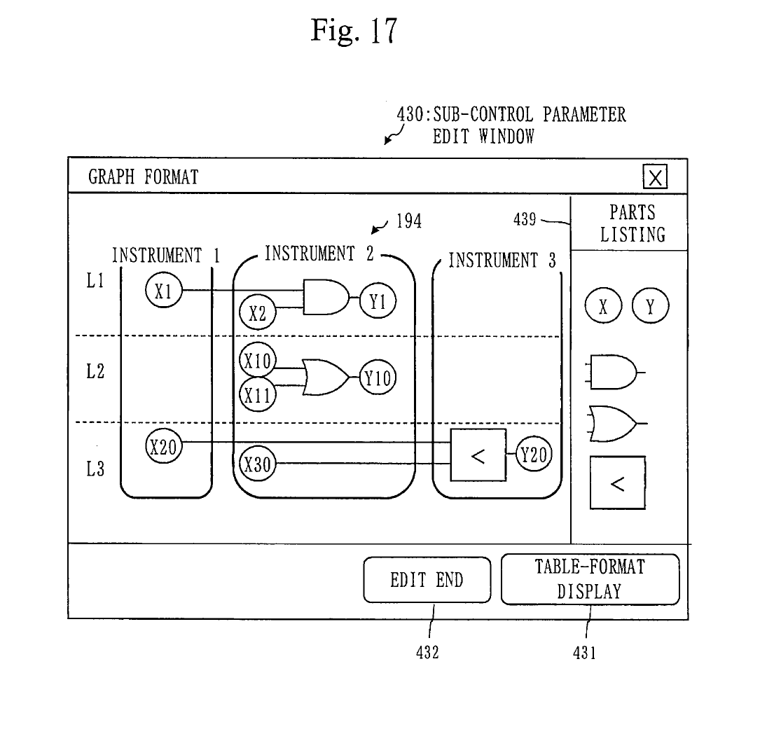

Note that a sub-control parameter graph display part 161 displays a sub-control parameter edit window 430 as illustrated in FIG. 17.

FIG. 17 is a diagram illustrating an example of the sub-control parameter edit window 430 according to Embodiment 3.

The sub-control parameter edit window 430 includes a sub-control parameter graph 194, a table-format display button 431, an edit end button 432, and a parts listing 439.

The parts listing 439 indicates icons expressing an input terminal, an output terminal, a logical product, a logical sum, magnitude comparison, and the like which are used in the sub-control parameter graph 194.

The edit end button 432 specifies to end editing the sub-control parameter graph 194.

The user selects an icon of the sub-control parameter graph 194 or the parts listing 439 by operating an input instrument and instructs to the sub-control parameter graph 194 to add, move, or delete an icon. For example, the user drags and drops an icon using a mouse.

The user also perform editing such as drawing a connection line that connects icons, specifying a terminal name to an input/output terminal, or the like by operating the input instrument.

When editing for the sub-control parameter graph 194 is ended, the user depresses the edit end button 432.

An edit instruction receiving part 115 receives an edit instruction of the user from the input instrument. A sub-control program edit part 116 adds, changes, or deletes an icon in the sub-control parameter graph 194 according to the edit instruction of the user.

When the edit end button 432 is depressed, the sub-control program edit part 116 (an example of the second program edit part) overwrites the edited data of the sub-control parameter graph 194 to the device storage part 190, and updates the sub-control program 212 in accordance with the data of the edited sub-control parameter graph 194.

According to Embodiment 3, the user can edit the sub-control program 212 visually. Namely, to edit the sub-control program 212 is facilitated.

### Embodiment 4

An embodiment will be described in which a command code not satisfying the constraint for the field instrument and network is to be converted according to a conversion rule.

Matters that are different from Embodiment 3 will mainly be described hereinafter. Matters that are not described are the same as Embodiment 3.

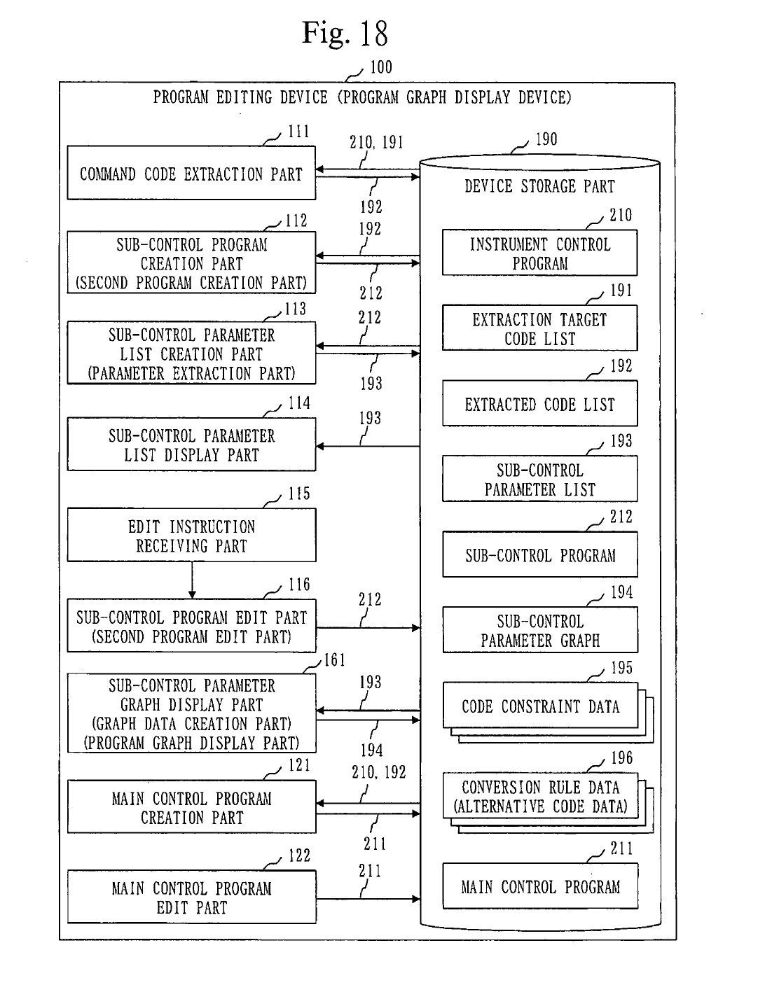

FIG. 18 is a functional configuration diagram of a program editing device 100 according to Embodiment 4.

The functional configuration of the program editing device 100 according to Embodiment 4 will be described by referring to FIG. 18.

A device storage part 190 of the program editing device 100 stores code constraint data 195 (an example of constraint data) and conversion rule data 196 (an example of alternative code data) for each field instrument type and each network type.

When a sub-control program edit part 116 (an example of a second program edit part) edits a sub-control program 212, a sub-control parameter list 193, or the sub-control parameter graph 194 according to the edit instruction of the user, the sub-control program edit part 116 converts a command code not satisfying the constraint that is set in the code constraint data 195 according to the conversion rule that is set in the conversion rule data 196.

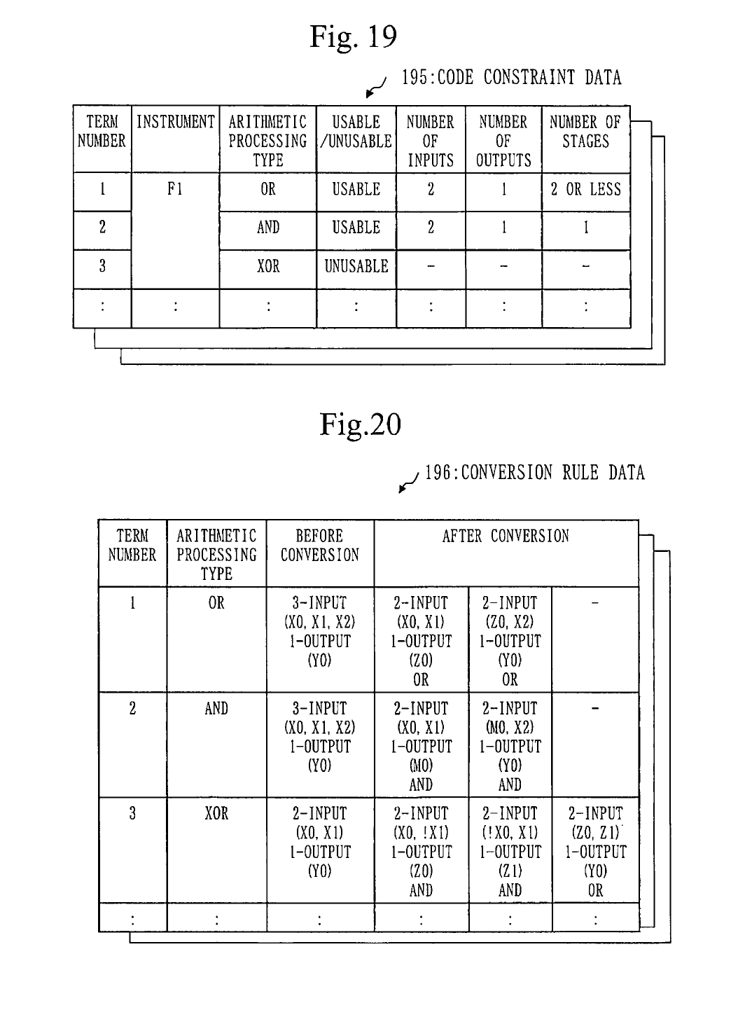

FIG. 19 is a diagram illustrating an example of a code constraint data 195 according to Embodiment 4.

An example of the code constraint data 195 according to Embodiment 4 will be described with reference to FIG. 19.

The code constraint data 195 is data indicating a constraint such as the type of arithmetic operation, input/output, or the like of each field instrument.

The code constraint data 195 associates the “instrument”, “arithmetic operation type”, “usable/nonusable”, “number of inputs”, “number of outputs”, and “number of stages” to each other.

The “instrument” indicates the identifier (name, number, or the like) of a field instrument.

The “arithmetic operation type” indicates the type of arithmetic operation (logical product, logical sum, or the like).

The “usable/nonusable” indicates whether or not the arithmetic operation (arithmetic operating element or arithmetic operation circuit) indicated in the “arithmetic operation type” can be employed.

The “number of inputs” indicates a condition on the number of inputs with respect to the arithmetic operation indicated by the “arithmetic operation type”.

The “number of outputs” indicates a condition on the number of outputs with respect to the arithmetic operation indicated by the “arithmetic operation”.

The “number of stages” indicates a condition on the number of stages that can use the arithmetic operation indicated by the “arithmetic operation type”. The number of states corresponds to the number of hierarchical levels for a case where a plurality of arithmetic operations are connected to establish a hierarchic relation (for example, the output of a first-level arithmetic operation is inputted to a second-level arithmetic operation).

For example, an instrument F1 can use a logical sum (OR) and a logical product (AND) but cannot use an exclusive logical sum (XOR) (refer to the usable/nonusable field).

A logical sum and a logical product each should have 2 inputs and 1 output (refer to the number-of-input field and number-of-output field).

Furthermore, a logical sum should be a first- or second-level arithmetic operation, and a logical product should be a first-stage arithmetic operation (refer to the number-of-levels field).

FIG. 20 is a diagram illustrating an example of the conversion rule data 196 according to Embodiment 4.

An example of the conversion rule data 196 according to Embodiment 4 will be described by referring to FIG. 20.

The conversion rule data 196 is data expressing the content of a pre-conversion command code and the content of a post-conversion command code of each arithmetic operation type.

The conversion rule data 196 associates “arithmetic operation type”, “pre-conversion”, and “post-conversion” to each other.

“Pre-conversion” indicates the content of a pre-conversion command code.

“Post-conversion” indicates the content of a post-conversion command code (an example of a group of alternative codes).

For example, a 3-input 1-output logical sum (OR) is converted into a 2-level logical sum of a 2-input 1-output logical sum and a 2-input 1-output logical sum according to the conversion rule indicated by term number 1.

Note that “Xn” (n is an integer of 0 or more) placed in input or output parentheses identifies an input terminal of a field instrument, “Yn” identifies an output terminal of the field instrument, “Zn” identifies an input/output terminal of an arithmetic operation (circuit or element), and “M0” identifies an internal memory of the field instrument. Also, “!” signifies negation.

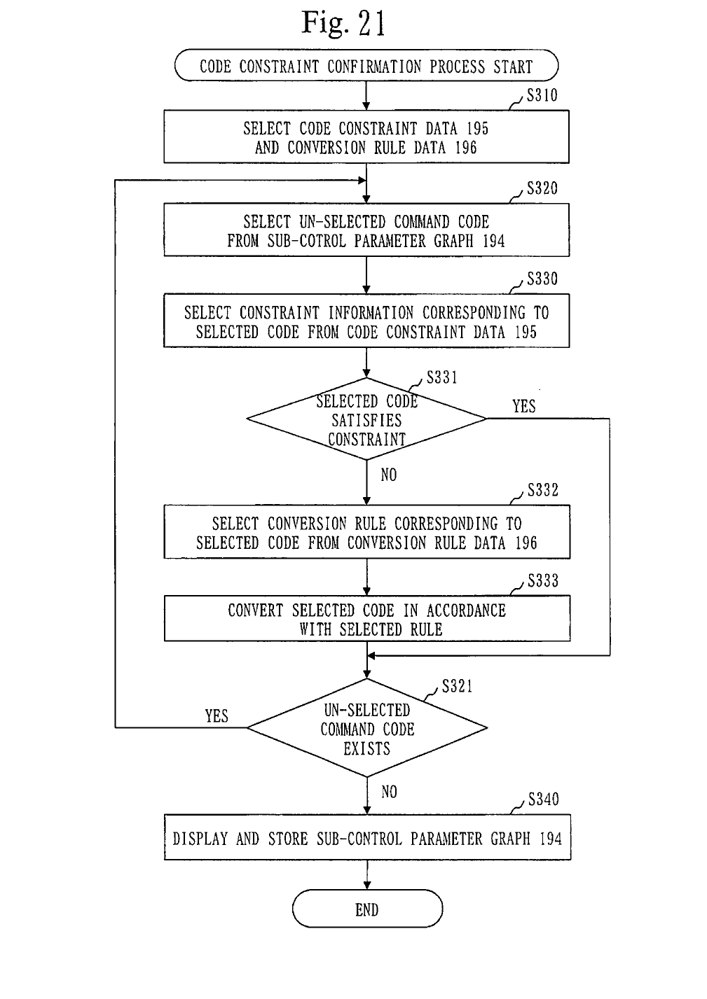

FIG. 21 is a flowchart illustrating a code constraint confirmation process of the sub-control program edit part 116 according to Embodiment 4.

When a sub-control parameter graph 194 is edited on a sub-control parameter edit window 430 (see FIG. 17), the sub-control program edit part 116 executes the code constraint confirmation process as follows.

In S310, the sub-control program edit part 116 selects code constraint data 195 and conversion rule data 196 for a target network, from among the plurality of pieces of code constraint data 195 and a plurality of pieces of conversion rule data 196.

After S310, the process proceeds to S320.

In S320, the sub-control program edit part 116 selects one un-selected command code from the sub-control parameter graph 194. The command code selected in S320 will be referred to as “selected code” hereinafter.

After S320, the process proceeds to S330.

In S330, the sub-control program edit part 116 selects constraint information corresponding to the selected code from the code constraint data 195. The constraint information selected in S330 will be referred to as “selected constraint” hereinafter.

After S330, the process proceeds to S331.

In S331, the sub-control program edit part 116 compares the selected code and the selected constraint and decides whether or not the selected code satisfies the selected constraint.

If the selected code satisfies the selected constraint (YES), the process proceeds to S321.

If the selected code does not satisfy the selected constraint (NO), the process proceeds to S332.

In S332, the sub-control program edit part 116 selects a conversion rule corresponding to the selected code from the conversion rule data 196. The conversion rule selected in S332 will be referred to as “selected rule” hereinafter.

After S332, the process proceeds to S333.

In S333, the sub-control program edit part 116 converts the selected code in accordance with the selected rule.

After S333, the process proceeds to S321.

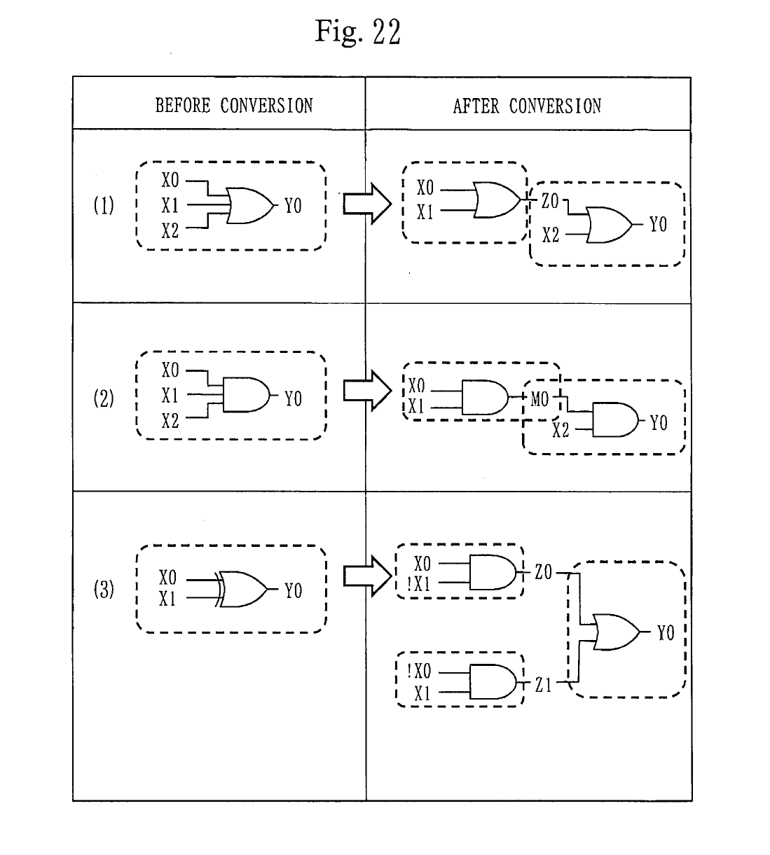

FIG. 22 is a diagram illustrating conversion examples of command codes according to Embodiment 4.

For example, the sub-control program edit part 116 converts command codes as illustrated in FIG. 22 based on the code constraint data 195 of FIG. 19 and the conversion rule data 196 of FIG. 20.

(1) The sub-control program edit part 116 converts a 3-input 1-output logical sum into a 2-level logical sum of a 2-input 1-output logical sum and a 2-input 1-output logical sum.

(2) The sub-control program edit part 116 converts a 3-input 1-output logical product into a 2-level logical product of a 2-input 1-output logical product and a 2-input 1-output logical product.

(3) The sub-control program edit part 116 converts a 2-input 1-output exclusive logical sum into a 2-level arithmetic operation of two 2-input 1-output logical products and a 2-input 1-output logical sum.

Returning to FIG. 21, the explanation will resume with S321.

In S321, the sub-control program edit part 116 decides whether or not an un-selected command code is left in the sub-control parameter graph 194.

If an un-selected command code is left (YES), the process returns to S320.

If an un-selected command code is not left (NO), the process proceeds to S340.

In S340, the sub-control program edit part 116 displays the converted sub-control parameter graph 194 on a sub-control parameter edit window 430, together with a message indicating that a command code not satisfying the constraint is converted.

The sub-control program edit part 116 also overwrites the converted sub-control parameter graph 194 to the device storage part 190.

Furthermore, the sub-control program edit part 116 updates the sub-control program 212 and the sub-control parameter list 193 to match the converted sub-control parameter graph 194.

After S340, the code constraint confirmation process ends.

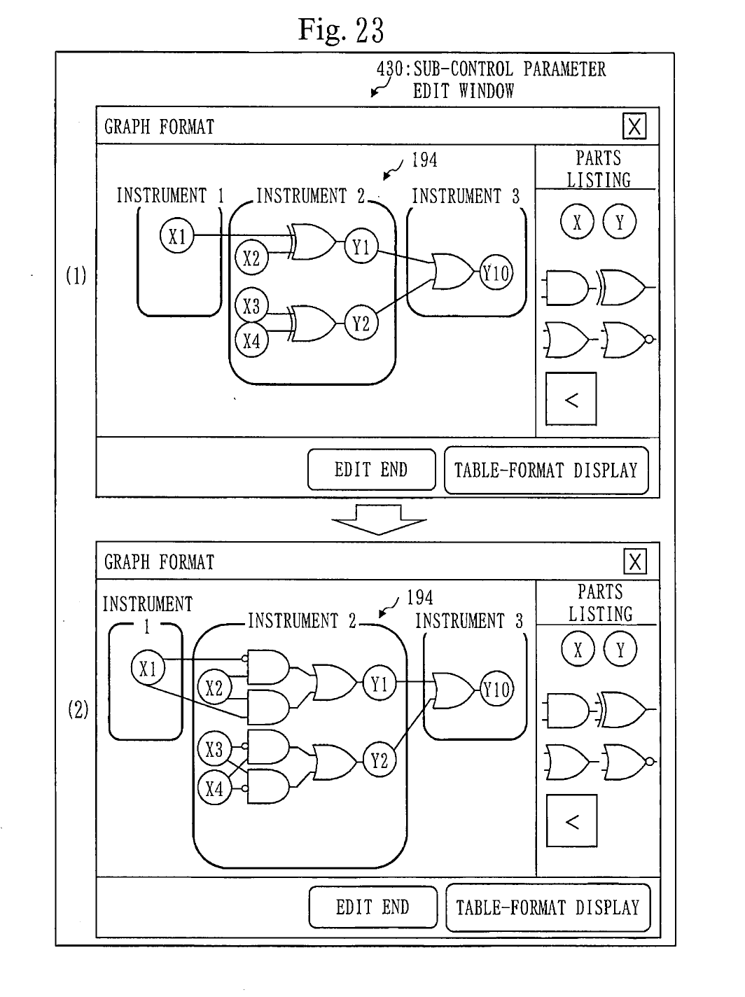

FIG. 23 is a diagram illustrating an example of the sub-control parameter edit window 430 according to Embodiment 4.

As illustrated in FIG. 23, the sub-control program edit part 116: (1) converts the command code of the sub-control parameter graph 194; and (2) displays the sub-control parameter graph 194 whose command code has been converted, on the sub-control parameter edit window 430. Note that in (2), among input lines extending from X1, X3, and X4 to logical products, an input line attached with a circular mark on the logical product side signifies an input of negation (inversion of an input value).

According to Embodiment 4, a command code not satisfying the constraints of the field instrument and network can be converted according to the conversion rule.

Namely, the user can edit the sub-control program 212 without being aware of the constraints of the field instrument and network.

### Embodiment 5

An embodiment will be described in which when a network or a field instrument is added, constraint information and a conversion rule are added.

Matters that are different from Embodiment 4 will mainly be described hereinafter. Matters that are not described are the same as Embodiment 4.

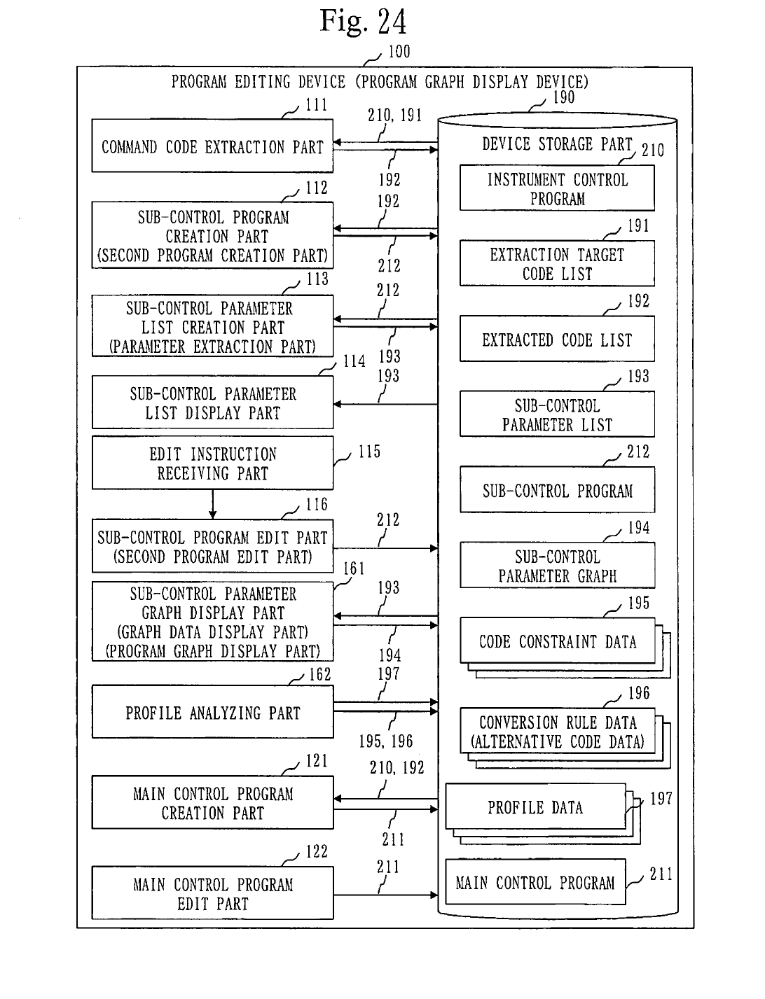

FIG. 24 is a functional configuration diagram of a program editing device 100 according to Embodiment 5.

The functional configuration of the program editing device 100 according to Embodiment 5 will be described by referring to FIG. 24.

The program editing device 100 includes a profile analyzing part 162 and profile data 197 in addition to the functional configuration described in Embodiment 4 (see FIG. 18).

The user enters the profile data 197 of a new network or a new field instrument to the program editing device 100. The profile data 197 is data including constraint information and information on a conversion rule.

The profile analyzing part 162 extracts the constraint information and the conversion rule from the entered profile data 197, creates code constraint data 195 including the extracted constraint information, and creates conversion rule data 196 including the extracted conversion rule.

According to Embodiment 5, constraint information and a conversion rule can be added when a network or a field instrument is added. Namely, the user can create the sub-control program 212 without being aware of the constraint even when a network or a field instrument is added.

The embodiments may be combined entirely or partly within a range where no inconsistency occurs.

### REFERENCE SIGNS LIST

100: program editing device; 111: command code extraction part; 112: sub-control program creation part; 113: sub-control parameter list creation part; 114: sub-control parameter list display part; 115: edit instruction receiving part; 116: sub-control program edit part; 121: main control program creation part; 122: main control program edit part; 161: sub-control parameter graph display part; 162: profile analyzing part; 190: device storage part; 191: extraction target code list; 192: extracted code list; 193: sub-control parameter list; 194: sub-control parameter graph; 195: code constraint data; 196: conversion rule data; 200: instrument control device; 201: CPU unit; 202: input/output unit; 204: network; 209: peripheral; 210: instrument control program; 211: main control program; 212: sub-control program; 310: sub-control parameter edit window; 311: edit end button; 410: graph-format display window; 411: table-format display button; 420: table-format display window; 421: graph-format display button; 430: sub-control parameter edit window; 431: table-format display button; 432: edit end button; 439: parts listing; 901: CPU; 902: bus; 903: ROM; 904: RAM; 905: communication board; 911: display; 912: keyboard; 913: mouse; 914: drive; 920: magnetic disk device; 921: OS; 922: programs; 923 files

1. A program graph display device comprising circuitry to
store, among a plurality of command codes included in a target program to be executed by a first execution part and a second execution part, a command code to be executed by the second execution part, as an extraction target code;
extract, from among the plurality of command codes included in the target program, a command code that is the same as the extraction target code stored as an extracted code;
create, as a second program to be executed by the second execution part, a program including the extracted code extracted;
extract, from each of one or more command codes included in the second program, each of one or more elements constituting the command code, as a parameter; and
create graph data that expresses, as a second program graph, a chart in which one or more parameters being extracted, of each command code are associated with each other.

2. The program graph display device according to claim 1, wherein the circuitry displays the second program graph based on the graph data created.

3. The program graph display device according to claim 2, wherein the circuitry edits the second program in accordance with an edit instruction for the second program graph displayed.

4. The program graph display device according to claim 3, wherein the circuitry
stores constraint data indicating a constraint for a command code related to the second execution part,
stores, for each command code, alternative code data indicating a group of alternative codes, as a plurality of command codes serving as an alternative,
selects, from among the command codes included in the second program edited, a command code not satisfying the constraint indicated by the constraint data, as a conversion target code,
selects alternative code data associated with a command code which is the same as the conversion target code selected, and
replaces the conversion target code selected, by a group of alternative codes indicated by the alternative code data selected.

5. The program graph display device according to claim 4, wherein the circuitry creates the constraint data and the alternative code data based on profile data specified as data including constraint information concerning the constraint and alternative code information concerning the group of alternative codes.

6. A program graph displaying method
storing, among a plurality of command codes included in a target program to be executed by a first execution part and a second execution part, a command code to be executed by the second execution part, as an extraction target code;
extracting, from among the plurality of command codes included in the target program, a command code that is the same as the extraction target code stored, as an extracted code;
creating, as a second program to be executed by the second execution part, a program including the extracted code that has been extracted;
extracting, from each of one or more command codes included in the second program, each of one or more elements constituting the command code, as a parameter; and
creating graph data that expresses, as a second program graph, a chart in which one or more parameters being extracted, of each command code are associated with each other.

7. A non-transitory computer readable medium including a program graph display program to cause a computer to function as the program graph display device according to claim 1.
